(19) United States
(12) Patent Application Publication
(10) Pub. No.: US 2004/0265734 A1
(43) Pub. Date: Dec. 30, 2004

(54) Photoresist performance through control of polymer characteristics

(76) Inventors: Wang Yueh, Portland, OR (US); Robert P. Meagley, Hillsboro, OR (US); Michael D. Goodner, Hillsboro, OR (US); Shan C. Clark, Forest Grove, OR (US); E. Steve Putna, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/610,054

(22) Filed: Jun. 30, 2003

(51) Int. Cl. G03C 1/76

(52) U.S. Cl. 430/270.1; 526/278; 422/132; 700/269

(57) ABSTRACT

A system, method, and software to form photoresist resin which has a more uniform distribution of polymers are disclosed. In one embodiment, the method includes introducing a first monomer into a reaction vessel; introducing a second monomer into the reaction vessel; and introducing an initiator into the reaction vessel to cause a polymerization of the first and second monomers, wherein the introducing the first and second monomers into the reaction vessel is performed in a manner that a concentration ratio of the first and second monomers is a function of a predetermined inverse relationship to a reactivity ratio of the first and second monomers. In another embodiment, the method includes introducing an initiator into the reaction vessel to cause a living or pseudo-living polymerization of the first and second monomers.

### FIELD

This disclosure relates generally to semiconductor processing material, and in particular, to a method of forming a photoresist material characterized in having a more uniform distribution of polymer resins which leads to improved line edge roughness (LER) and fewer feature defects.

### BACKGROUND

Chemically amplified (CA) photoresists used in lithography typically consists of several primary components: a resin (also referred to as a matrix material), a photoacid generator (PAG)), a quencher, and a solvent. The resin serves as a binder, and establishes the mechanical properties of the film. The PAG is the component of the resist material that reacts in response to a specified type of incident radiation. The quencher moderates the effect of the PAG and renders the photoresist less susceptible to environmental effects. The solvent keeps the resist in liquid state until it is applied to the layer being processed. This disclosure relates specifically to the resin component of the photoresist.

A resin is a polymeric structure made up different molecular weight and structured polymers. Some of the polymers are homogeneous polymers consisting primarily of a chain of a single-type monomer. Others are copolymers consisting of a chain of two or more monomers. It has been observed that the line edge roughness (LER) and the occurrence of feature defects are dependent on the uniformity of the polymers in a photoresist resin. More specifically, the line edge roughness (LER) and occurrence of feature defects are dependent on the uniformity of the molecular weight distribution of the polymers and the structural distribution of the polymers. It has been noted that improvement in the line edge roughness (LER) and reduction in feature defects can result if the uniformity of the molecular weight distribution and structure distribution is improved.

Photoresist resin manufacturers typically use rudimentary techniques to control resin composition. They primarily use one-pot synthesis methods, which result in relatively non-uniform polymer structure distribution and molecular weight distribution. For instance, such manufacturers typically do not control the concentration and feed rates of the monomers into the reaction vessel. Such poorly-controlled methods limit the improvement in the line edge roughness (LER) and leads to relatively high defect rates. This concept is further explained with reference to the following example.

FIG. 1 illustrates a diagram of an exemplary conventional one-pot synthesis system 100 for forming photoresist. The system 100 consists of a reaction vessel 102, an agitator 104, an input 106 to the reaction vessel 102, and a source for the monomers A and B and initiator solvents that are the raw material for forming the photoresist. As noted in FIG. 1, the monomers A and B and the initiator solvents are introduced into the reaction vessel 102 by way of a single input 106. In addition, the feed rates and concentrations of the monomers A and B and the initiators are typically not well-controlled, which leads to the formation of a relatively disperse distribution of polymers and copolymers in the photoresist. As discussed above, the relatively disperse distribution of polymers and copolymers in the photoresist is a source of feature defects as well as limits the improvement of the line edge roughness (LER).

FIG. 2 illustrates a graph of a molecular weight distribution of the polymers formed by the conventional one-pot synthesis system 100. In this example, monomer A is lactone and monomer B is a cage compound (PG). The reactivity of Lactone is significantly greater than the reactivity of the cage compound (PG). Due to the relatively large reactivity ratio between monomers A and B, the prior art one-pot synthesis reaction form four distinct polymer structures. In an early stage of the reaction, monomer A is able to successfully homopolymerize at a kinetic rate greater than copolymerization or homopolymerization of monomer B. This is shown in the graph as the positive slope of the molecular weight distribution. During an early-to-middle phase of the reaction, copolymers rich in monomer A forms. This is shown in the graph as the region having a higher molecular weight. During a middle-to-late phase of the reaction, copolymers rich in monomer B are formed. This is shown in the graph as the low negative slope of the molecular weight distribution plot. And, during the late phase of the reaction, homopolymerization of monomer B occurs due to the lack of monomer A.

The different polymers in the photoresist resin have different etch properties. For instance, low molecular weight polymers consisting primarily of Lactone are less soluble when exposed. On the other hand, high molecular weight polymers consisting primarily of Lactone have a relatively fast etch rate. Low molecular weight polymers consisting primarily of the cage compound (PG) have a relatively slow etch rate. If there is a wide distribution of such polymers in a photoresist, the dissolution rate of the photoresist is not uniform throughout the film. This leads to feature defects and limits the improvement of the line edge roughness (LER).

### BRIEF DESCRIPTION OF THE DRAWINGS

FIG. 1 illustrates a diagram of an exemplary conventional one-pot synthesis system for forming photoresist;

FIG. 2 illustrates a graph of a molecular weight distribution of the polymers formed by the conventional one-pot synthesis system; and

FIG. 3 illustrates a diagram of an exemplary system for forming photoresist in accordance with an embodiment of the invention.

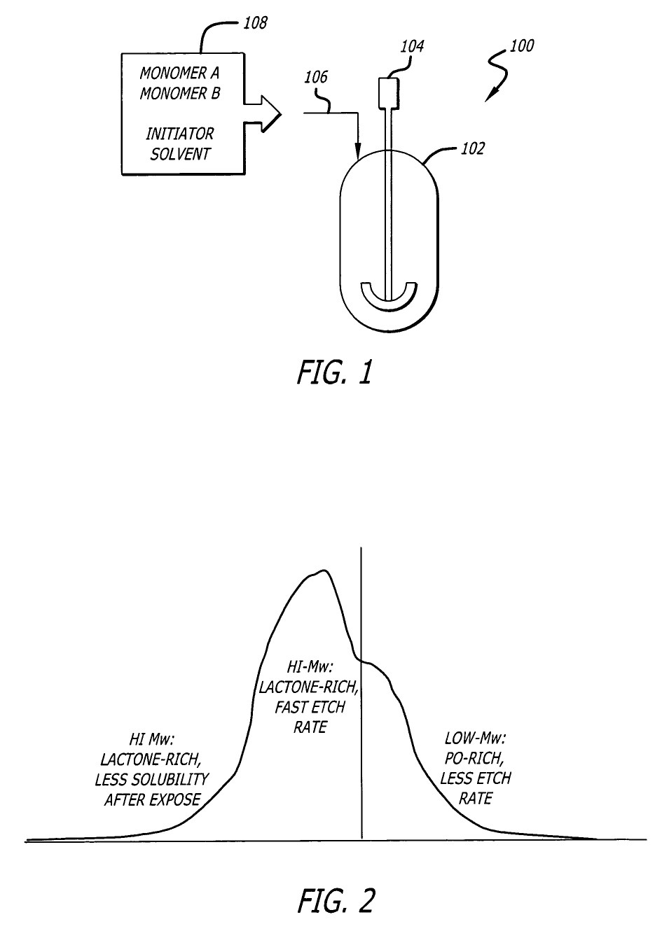

### DETAILED DESCRIPTION

A method of forming photoresist in accordance with an embodiment of the invention entails controlling the polymerization of two or more monomers to provide a more uniform distribution of the polymers. A photoresist having a more uniform distribution of polymers means that the polymers are more uniform in their structure and their molecular weight. For instance, in the case where the polymers are formed of two distinct monomers A and B, the majority of the polymers formed would be a copolymerization of monomers A and B, whereby a minority of the polymers formed are homopolymerizations of monomers A and B. In terms of molecular weight, the molecular weight distribution of copolymers A-B would be more uniformly centered around a particular molecular weight. Again, the more uniform polymers in a photoresist in terms of their structure and molecular weight, the more uniform is its dissolution rate, resulting in improved line edge roughness (LER) and fewer feature defects.

According to the method, the improved uniformity of the polymers in a photoresist is achieved by one or more of the following techniques: (1) independently controlling the feed rates and concentrations of the monomers and the initiator into the reaction vessel; (2) controlling the reaction temperature in order to minimize the reactivity ratios between the monomers; and (3) using living or pseudo-living polymerization techniques.

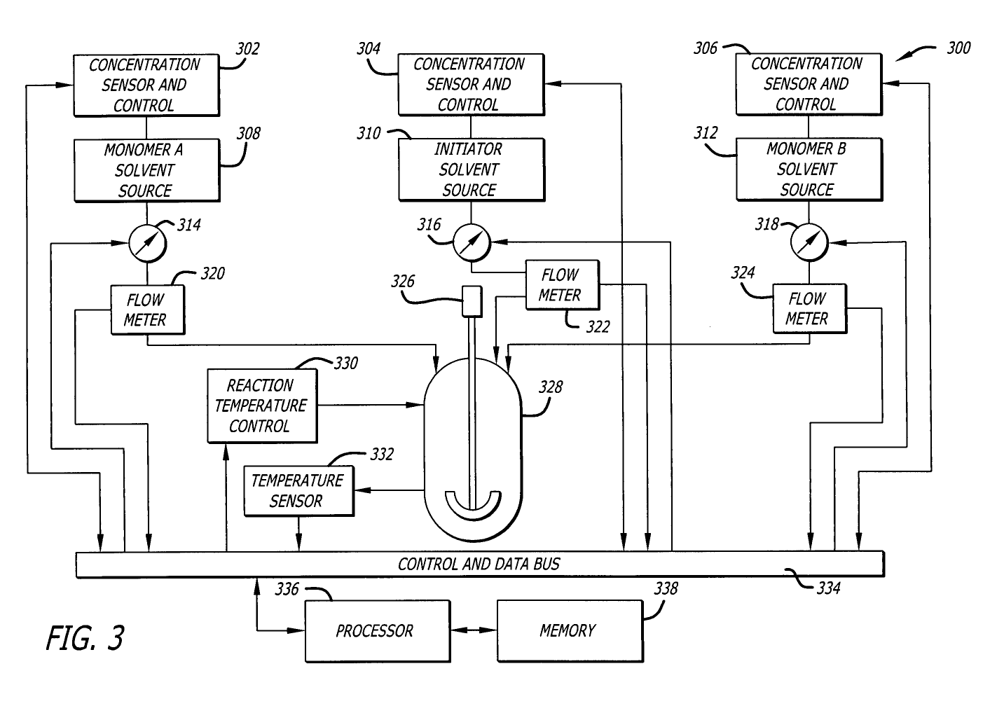

FIG. 3 illustrates a diagram of an exemplary system 300 for forming photoresist in accordance with an embodiment of the invention. The system 300 comprises a reaction vessel 328 having an agitator 326, a reaction temperature control 330 to control the reaction temperature within the vessel 328, and a temperature sensor 332 to generate a temperature signal indicative of the reaction temperature within the vessel 328.

In addition, the system 300 comprises a monomer A solvent source 308 (e.g. lactone) fluidly coupled to the reaction vessel 328 by way of a variable-flow valve 314 and flow meter 320. In addition, the system 300 includes a concentration sensor and control 302 to control the concentration of monomer A in the monomer A solvent source 308. The system 300 further comprises a monomer B source 312 (e.g. a cage compound) fluidly coupled to the reaction vessel 328 by way of a variable-flow valve 318 and flow meter 324. In addition, the system 300 includes a concentration sensor and control 306 to control the concentration of monomer B in the monomer B solvent source 312. Additionally, the system 300 comprises an initiator (either neat or dissolved in solvent) source 310 (e.g. azobisisobutyronitrile (ATBN), Peroxidebenzenc, etc.) fluidly coupled to the reaction vessel 328 by way of a variable-flow valve 316 and flow meter 322. In addition, the system 300 includes a concentration sensor and control 304 to control the concentration of the initiator in the initiator/solvent source 310.

The system 300 further comprises a processor 336 to control the various operations of the system 300, a memory 338 (i.e. a computer readable medium) to store data and one or more software modules that controls the processor 336 in performing its intended operations, and a control and data bus 334 to serve as a communications link between the various modules of the system and the processor 336. More specifically, the processor 336 by way of the control and data bus 334 is communicatively coupled to the concentration sensor and controls 302, 304, and 306, the variable-flow valves 314, 316, and 318, the flow meters 320, 322, and 324, the reaction temperature control 330, and the temperature sensor 332.

As previously discussed, to improve the line edge roughness (LER) and reduce feature defects, a more uniform distribution of the polymers in a photoresist is desired. Accordingly, the system 300 provides independent control of the feed rates of monomers A and B and initiator solvents into the reaction vessel 328, independent control of the concentrations of monomers A and B and the initiator in their respective solvents, and independent control of the reaction temperature within the vessel 328.

With regard to the independent control of the feed rates of the monomers A and B into the reaction vessel 328, the processor 336, under the control of the one or more software modules stored in the memory 338, controls the feed rates and concentrations of the monomers A and B such that the concentration ratio of monomers A and B is inversely related to the reactivity ratio of monomers A and B. With regard the independent control of the feed rate and concentration of the initiator into the reaction vessel 328, the processor 336, under the control of the one or more software modules stored in the memory 338, controls the feed rate and concentration of the initiator into the such that the concentration of the initiator in the reaction vessel 328 produces a controlled reaction which forms a more uniform molecular weight of copolymers made of monomers A and B. With regard to the temperature control of the reaction temperature, the processor 336, under the control of the one or more software modules stored in the memory 338, controls the reaction temperature within the vessel 328 so as to minimize the reactivity ratio of monomers A and B.

More specifically, so as to provide a more uniform distribution of polymers formed in the reaction vessel 328, the concentration of monomer A in the reaction vessel 328 should be related to the reactivity ratio of monomer A and B. Likewise, the concentration of monomer B in the reaction vessel 328 should be related to the reactivity ratio of monomers A and B. If, for example, the reactivity of monomer A is greater than the reactivity of monomer B, then the concentration of monomer B within the reaction vessel 328 should be greater than monomer A so that the primary polymers formed are copolymers of monomers A and B. Otherwise, if the concentrations of monomers A and B in the reaction vessel 328 were the same, homopolymerization of monomers A would be the primary polymer formed in the reaction vessel because monomer A is more reactive. Accordingly, the concentration ratio of monomers A and B within the reaction vessel 328 should be inversely related to the reactivity ratio of monomers A and B.

In order to achieve this relationship within the reaction vessel 328, the processor 336, under the control of the one or more software modules stored in the memory 338, may control one or more of the concentration sensors and controls 302 and 306 and the variable-flow valves 314 and 318 associated with monomers A and B. For instance, if the feed rates of monomers A and B into the reaction vessel 328 are fixed, and the concentration of monomer B in the monomer B solvent source 312 is fixed, the processor 336 may control the concentration sensor and control 302 such that the concentration of monomer A in the source 308 is such that a predetermined inverse relationship exists between the concentration ratio of monomers A and B and the reactivity ratio of monomers A and B within the vessel 328. Similarly, if the feed rates of monomers A and B into the reaction vessel 328 are fixed, and the concentrations of monomers A and B in respective sources A and B 308 and 312 are variable, the processor 336 may control the concentration sensors and controls 302 and 306 such that a predetermined inverse relationship exists between the concentration ratio of monomers A and B and the reactivity ratio of monomers A and B within the vessel 328.

Alternatively, if the concentrations of monomers A and B in their respective sources 308 and 312 are fixed, and the flow rate of monomer B into the reaction vessel 328 is fixed, the processor 336, under the control of the one or more software modules stored in the memory 338, controls the variable-flow valve 314 such that the feed rate of monomer A into the reaction vessel 328 is such that a predetermined inverse relationship exists between the concentration ratio of monomers A and B and the reactivity ratio of monomers A and B within the vessel 328. Or, if the concentrations of monomers A and B in their respective sources 308 and 312 are fixed, and the flow rates of monomers A and B into the reaction vessel 328 is variable, the processor 336, under the control of the one or more software modules stored in the memory 338, controls the variable-flow valves 314 and 318 such that the feed rates of monomers A and B into the reaction vessel 328 is such that a predetermined inverse relationship exists between the concentration ratio of monomers A and B and the reactivity ratio of monomers A and B within the vessel 328.

These examples show that one or more of the concentration sensors and controls 302 and 306 and the variable-flow valves 314 and 316 can be controlled, by the processor 336, to establish a predetermined inverse relationship exists between the concentration ratio of monomers A and B and the reactivity ratio of monomers A and B within the vessel 328. In fact, the processor 336 may independently control all the of the concentration sensors and controls 302 and 306 and the variable-flow valves 314 and 316 to establish a predetermined inverse relationship between the concentration ratio of monomers A and B and the reactivity ratio of monomers A and B within the vessel 328.

In order to provide a more controlled reaction in the vessel 328 such that a more uniform distribution of polymers are formed within the vessel 328, the processor 336 may control the concentration sensor and control 304 and/or variable-flow valve 316 so that the concentration of the initiator in the vessel 328 produces a more controlled reaction such that copolymers of monomers A and B with a desired molecular weight specification are formed within the vessel 328. Again, the processor 336 can control either or both the concentration sensor and control 304 and variable-flow valve 316.

In addition, the processor 336 may control the reaction temperature within the vessel 328 so as to minimize the reactivity ratio between monomers A and B. In such endeavor, the processor 336 receives reaction temperature data from the temperature sensor 332 by way of the control and data bus 334. Based on the reaction temperature data, the processor 336 instructs the reaction temperature control 330 to adjust the reaction temperature (e.g. 60-80° C. for monomers A being lactone and monomers B being cage compound) such that the reactivity ratio between monomers A and B is substantially minimized. In addition, the reaction temperature may be controlled with the use of a low temperature thermal initiator, a photoinitiator, or other suitable initiation systems.

Alternatively, or in addition to, the uniformity of the polymer structure and molecular weight distribution of the photoresist may be controlled using living or pseudo-living polymerization techniques. Living polymerization techniques are characterized as follows: (1) polymerization proceeds until all the monomers has been consumed, wherein further addition of monomer results in continued polymerization; (2) the number average molecular weight (or the number average degree of polymerization) is a linear function of conversion; (3) the number of polymer molecules (and active centers) is substantially a constant; (4) the molecular weight of the polymer can be controlled by the stoichiometry of the reaction; (5) narrow-molecular-weight distribution polymers are produced; (6) block copolymers can be prepared by sequential monomer addition; (7) chain-end functionalized polymers can be prepared in quantitative yield; (8) linearity of a kinetic plot rate of propagation as a function of time; and (9) linear dependence of the degree of polymerization as a function of time. If the reaction meet some, but not all, of the preceding conditions of a living polymerization, the reaction is typically termed a pseudo-living polymerization.

The system 300 can be configured to perform a living polymerization of the photoresist polymers formed in the reaction vessel 328. For instance, the initiator may be selected (e.g. Tempo), and its concentration and feed rates into the reaction vessel 328 may be controlled by the processor 336, to foster a living or pseudo-living polymerization; the concentration and feed rates of the one or more monomers (e.g. monomers A and B) into the reaction vessel 328 may be controlled by the processor 336 to foster a living or pseudo-living polymerization; and the reaction temperature (e.g. 120-140° C. for monomer A being lactone and monomer B being a cage compound) may be controlled to foster a living or pseudo-living polymerization. The living or pseudo-living polymerization can generate photoresist having a more uniform distribution of polymer structures and their molecular weights. Such a photoresist may lead to improve line edge roughness (LER) and fewer defects when used in photo lithography.

The photoresist forming process may be applied to all lithography nodes including 248 nanometers (nm), 193 nm, 157 nm, EUV, and all next generation lithography.

In the foregoing specification, the disclosure has been described with reference to specific embodiments thereof. It will, however, be evident that various modifications and changes may be made thereto without departing from the broader spirit and scope of the embodiments of the invention. The specification and drawings are, accordingly, to be regarded in an illustrative rather than a restrictive sense.

It is claimed:

1. A method of forming a photoresist, comprising:
introducing a first monomer into a reaction vessel;
introducing a second monomer into said reaction vessel; and
introducing an initiator into said reaction vessel to cause a polymerization of said first and second monomers, wherein said introducing said first and second monomers into said reaction vessel is performed in a manner that a concentration ratio of said first and second monomers in said reaction vessel is a function of a predetermined inverse relationship to a reactivity ratio of said first and second monomers.

2. The method of claim 1, further comprising controlling a feed rate of said first monomer into said reaction vessel.

3. The method of claim 1, further comprising controlling a concentration of said first monomer in a first monomer solvent source.

4. The method of claim 1, further comprising controlling a feed rate of said initiator into said reaction vessel.

5. The method of claim 1, further comprising controlling a concentration of said initiator in an initiator solvent source.

6. The method of claim 1, further comprising controlling a reaction temperature within said reaction vessel to set said reactivity ratio of said monomers A and B to a predetermined value.

7. The method of claim 1, wherein said first monomer comprises lactone and said second monomer comprises a cage compound.

8. The method of claim 1, wherein said initiator comprises a low temperature free-radical thermal initiator.

9. A computer readable medium including one or more software modules to form photoresist by causing:
an introduction of a first monomer into a reaction vessel;
an introduction of a second monomer into said reaction vessel; and
an introduction of an initiator into said reaction vessel to cause a polymerization of said first and second monomers, wherein said introducing said first and second monomers into said reaction vessel is performed in a manner that a concentration ratio of said first and second monomers in said reaction vessel is a function of a predetermined inverse relationship to a reactivity ratio of said first and second monomers.

10. The computer readable medium of claim 9, wherein said one or more software modules to control a feed rate of said first monomer into said reaction vessel.

11. The computer readable medium of claim 9, wherein said one or more software modules to control a concentration of said first monomer in a first monomer solvent source.

12. The computer readable medium of claim 9, wherein said one or more software modules to control a feed rate of said initiator into said reaction vessel.

13. The computer readable medium of claim 9, wherein said one or more software modules to control a concentration of said initiator in a initiator solvent source.

14. The computer readable medium of claim 9, wherein said one or more software modules to control a reaction temperature within said reaction vessel to set said reactivity ratio of said first and second monomers to a predetermined value.

15. The computer readable medium of claim 9, wherein said first monomer comprises lactone and said second monomer comprises a cage compound.

16. The computer readable medium of claim 1, wherein said initiator comprises a low temperature free-radical thermal initiator.

17. The computer readable medium of claim 1, wherein said initiator comprises a photoinitiator.

18. A system to form a photoresist, comprising:
a reaction vessel;
a first monomer solvent source;
a second monomer solvent source;
an initiator solvent source; and
a processor to cause:
an introduction of a first monomer from said first monomer solvent source into said reaction vessel;
an introduction of a second monomer from said second monomer solvent source into said reaction vessel; and
an introduction of an initiator from said initiator solvent source into said reaction vessel to cause a polymerization of said first and second monomers, wherein said introduction of said first and second monomers into said reaction vessel is performed in a manner that a concentration ratio of said first and second monomers in said reaction vessel is a function of a predetermined inverse relationship to a reactivity ratio of said first and second monomers.

19. The system of claim 18, further comprising one or more variable-flow valves coupled respectively between said first monomer solvent source, second monomer solvent source, and said initiator solvent source and said reaction vessel, wherein said processor is coupled to said one or more variable-flow values to control the respective feed rates of said first monomer, second monomer, and said initiator into said reaction vessel.

20. The system of claim 18, further comprising one or more concentration sensors and controls respectively coupled to said first monomer solvent source, said second monomer solvent source, and said initiator solvent source, wherein said processor is coupled to said one or more concentration sensors and controls to control the respective concentrations of said first monomer, second monomer, and said initiator in said first monomer solvent source, said second monomer solvent source, and said initiator solvent source, respectively.

21. The system of claim 18, further comprising:
a reaction temperature control to control a reaction temperature within said reaction vessel; and
a temperature sensor to generate a temperature signal indicative of said reaction temperature within said reaction vessel, wherein said processor controls said reaction temperature control in response to said temperature signal generated by said temperature sensor.

22. A method of forming a photoresist, comprising:
introducing a first monomer into a reaction vessel;
introducing a second monomer into said reaction vessel; and
introducing an initiator into said reaction vessel to cause a living or pseudo-living polymerization of said first and second monomers.

23. The method of claim 22, further comprising controlling a feed rate of said first monomer into said reaction vessel.

24. The method of claim 22, further comprising controlling a concentration of said first monomer in a first monomer solvent source.

25. The method of claim 22, further comprising controlling a feed rate of said initiator into said reaction vessel.

26. The method of claim 22, further comprising controlling a concentration of said initiator in a initiator solvent source.

27. The method of claim 22, further comprising controlling a reaction temperature within said reaction vessel to set said reactivity ratio of said first and second monomers to a predetermined value.

28. The method of claim 22, wherein said first monomer comprises lactone and said second monomer comprises a cage compound.

29. A computer readable medium including one or more software modules to form photoresist by causing:
an introduction of a first monomer into a reaction vessel;
an introduction of a second monomer into said reaction vessel; and
an introduction of an initiator into said reaction vessel to cause a living or pseudo-living polymerization of said first and second monomers.

30. The computer readable medium of claim 29, wherein said one or more software modules to control a feed rate of said first monomer into said reaction vessel.

31. The computer readable medium of claim 29, wherein said one or more software modules to control a concentration of said first monomer in a first monomer solvent source.

32. The computer readable medium of claim 29, wherein said one or more software modules to control a feed rate of said initiator into said reaction vessel.

33. The computer readable medium of claim 29, wherein said one or more software modules to control a concentration of said initiator in an initiator solvent source.

34. The computer readable medium of claim 29, wherein said one or more software modules to control a reaction temperature within said reaction vessel to set said reactivity ratio of said first and second monomers to a predetermined value.

35. The computer readable medium of claim 29, wherein said first monomer comprises lactone and said second monomer comprises a cage compound.

36. The computer readable medium of claim 29, wherein said initiator comprises a low temperature free-radical thermal initiator.

37. The computer readable medium of claim 29, wherein said initiator comprises a photoinitiator.

38. A system to form a photoresist, comprising:
a reaction vessel;
a first monomer solvent source;
a second monomer solvent source;
an initiator solvent source; and
a processor to cause:
an introduction of a first monomer from said first monomer solvent source into said reaction vessel;
an introduction of a second monomer from said second monomer solvent source into said reaction vessel; and
an introduction of an initiator from said initiator solvent source into said reaction vessel to cause a living or pseudo-living polymerization of said first and second monomers.

39. The system of claim 38, further comprising one or more variable-flow valves coupled respectively between said first monomer solvent source, second monomer solvent source, and said initiator solvent source and said reaction vessel, wherein said processor is coupled to said one or more variable-flow values to control the respective feed rates of said first monomer, second monomer, and said initiator into said reaction vessel.

40. The system of claim 38, further comprising one or more concentration sensors and controls respectively coupled to said first monomer solvent source, said second monomer solvent source, and said initiator solvent source, wherein said processor is coupled to said one or more concentration sensors and controls to control the respective concentrations of said first monomer, second monomer, and said initiator in said first monomer solvent source, said second monomer solvent source, and said initiator solvent source, respectively.

41. The system of claim 38, further comprising:
a reaction temperature control to control a reaction temperature within said reaction vessel; and
a temperature sensor to generate a temperature signal indicative of said reaction temperature within said reaction vessel, wherein said processor controls said reaction temperature control in response to said temperature signal generated by said temperature sensor.
